(19) United States
(12) Patent Application Publication
(10) Pub. No.: US 2013/0063542 A1
(43) Pub. Date: Mar. 14, 2013

(54) SYSTEM AND METHOD FOR CONFIGURING VIDEO DATA

(71) Applicants: Raghurama Bhat, Cupertino, CA (US); Joseph Fouad Khouri, San Jose, CA (US); Ashish S. Chirputkar, Fremont, CA (US); Muralidhar K. Sitaram, Los Altos, CA (US)

(72) Inventors: Raghurama Bhat, Cupertino, CA (US); Joseph Fouad Khouri, San Jose, CA (US); Ashish S. Chirputkar, Fremont, CA (US); Muralidhar K. Sitaram, Los Altos, CA (US)

(73) Assignee: Cisco Technology, Inc.

(21) Appl. No.: 13/232,264

(22) Filed: Sep. 14, 2011

(51) Int. Cl. H04N 7/15

(52) U.S. Cl. 348/14.03; 348/14.01; 348/E07.083

(57) ABSTRACT

A method is provided in one example implementation and includes receiving video data associated with a plurality of video streams during a communication session; receiving a rule selection for a particular video stream that is selected from the plurality of video streams; and displaying the particular video stream based on the rule selection. In more specific examples, the rule selection includes a designation for a video stream corresponding to an active speaker in the communication session, or a designation for a video stream associated with speech that is spoken prior to the active speaker in the communication session, or a designation for a video stream associated with a particular word recited in the communication session, or a designation for a video stream associated with a profile, which identifies an expertise of a participant of the communication session.

### TECHNICAL FIELD

This disclosure relates in general to the field of communications and, more particularly, to a system and a method for configuring multichannel video data in a meeting session environment.

### BACKGROUND

In certain architectures, sophisticated virtual online conferencing services can be provided for end users operating computing devices. A conferencing architecture can offer an “in-person” meeting experience over a computer network. Conferencing architectures can also deliver real-time interactions between people using advanced visual, audio, and multimedia technologies. Virtual meetings and conferences have an appeal because they can be held without the associated travel inconveniences and costs. In addition, virtual meetings can provide a sense of community to participants: many of whom are dispersed geographically.

Further, in some virtual meeting scenarios, meeting participants may be able to display multiple video streams from other participants, as well as hear an audio stream of the meeting. In certain scenarios, each participant's meeting experience may be problematic, as they are forced to monitor several video streams (all at once). Allowing meeting participants to intelligently control video streams (e.g., for suitable display) offers a significant challenge for network operators, system designers, and component manufacturers alike.

### BRIEF DESCRIPTION OF THE DRAWINGS

To provide a more complete understanding of the present disclosure and features and advantages thereof, reference is made to the following description, taken in conjunction with the accompanying figures, wherein like reference numerals represent like parts, in which:

FIG. 1A is a simplified schematic diagram of a communication system for intelligently configuring multichannel video data in accordance with one embodiment of the present disclosure;

FIG. 1B is a simplified block diagram illustrating one possible implementation associated with the present disclosure;

FIG. 2 is a simplified flowchart illustrating example operations associated with the present disclosure;

FIG. 3 is a simplified schematic diagram illustrating possible details related to an example infrastructure of the communication system in accordance with one embodiment;

FIGS. 4A-4B are simplified schematic diagrams illustrating example user interface graphics associated with possible implementations of the communication system;

FIG. 5 is a simplified schematic diagram illustrating example user interface graphics associated with a possible implementation of the communication system;

FIG. 6 is a simplified schematic diagram illustrating possible details related to an example infrastructure of the communication system in accordance with one embodiment; and

FIG. 7 is a simplified flowchart illustrating example activities associated with displaying video data for virtual meeting participants in the communication system.

### DETAILED DESCRIPTION OF EXAMPLE EMBODIMENTS

### OVERVIEW

A method is provided in one example implementation and includes receiving video data associated with a plurality of video streams during a communication session; receiving a rule selection for a particular video stream that is selected from the plurality of video streams; and displaying the particular video stream based on the rule selection. In more specific examples, the rule selection includes a designation for a video stream corresponding to an active speaker in the communication session, or a designation for a video stream associated with speech that is spoken prior to the active speaker in the communication session, or a designation for a video stream associated with a particular word recited in the communication session, or a designation for a video stream associated with a profile, which identifies an expertise of a participant of the communication session, or a designation for a video stream associated with a profile, which identifies a job characteristic of a participant of the communication session.

### EXAMPLE EMBODIMENTS

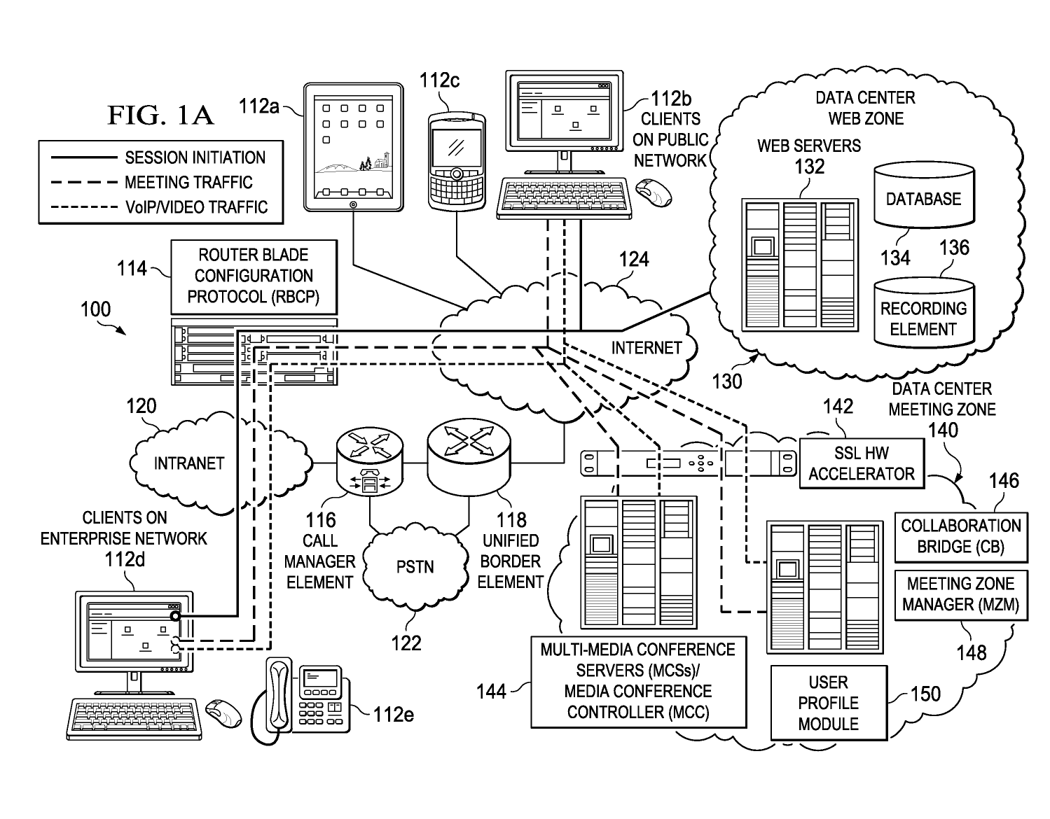

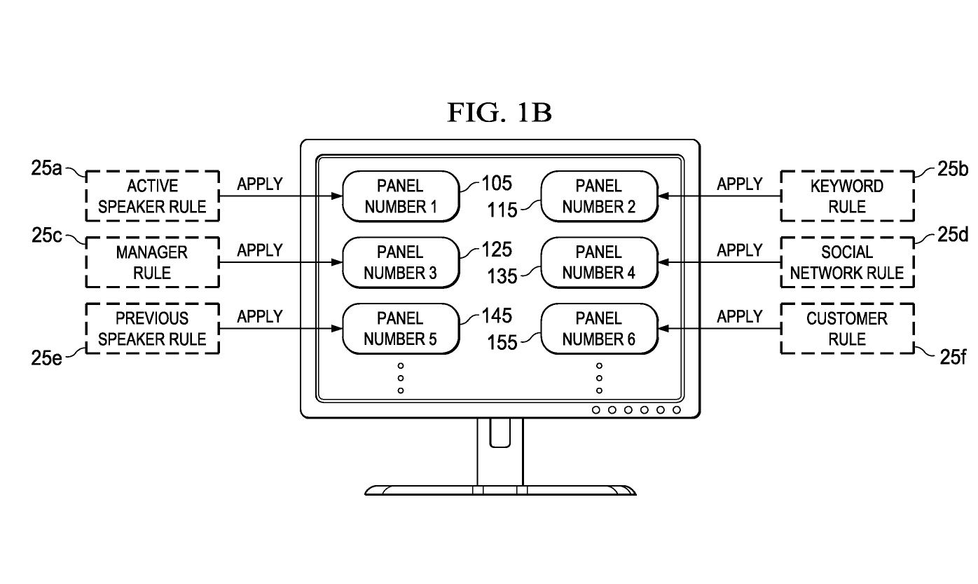

FIG. 1A is a simplified block diagram illustrating a communication system 100 for configuring multichannel video data in a meeting session environment. In specific implementations, communication system 100 can be provisioned for use in generating, managing, hosting, and/or otherwise providing virtual meetings. In certain scenarios (many of which are detailed below), communication system 100 may be configured for providing a rule-based display of multichannel video streams propagating in a network. The architecture of communication system 100 is applicable to any type of conferencing or meeting technology such as video conferencing architectures (e.g., Telepresence™), web cam configurations, smartphone deployments, personal computing applications (e.g., Skype™), multimedia meeting platforms (e.g., MeetingPlace™, WebEx™, etc.), desktop applications, or any other suitable environment in which video data is sought to be managed.

Communication system 100 may include any number of endpoints 112a-e that can achieve suitable network connectivity via various points of attachment. In this particular example, communication system 100 can include an Intranet 120, a public switched telephone network (PSTN) 122, and an Internet 124, which (in this particular example) offers a pathway to a data center web zone 130 and a data center meeting zone 140.

Turning briefly to FIG. 1B, FIG. 1B is a simplified block diagram illustrating one example implementation associated with the present disclosure. This particular implementation includes a plurality of panels 105, 115, 125, 135, 145, 155 that can be rendered on a given graphical user interface (GUI). Additionally, a number of rules 25a-f are shown as being applied to individual panels, which are labeled #1-#6. Each of panels 105, 115, 125, 135, 145, 155 renders a particular video stream based on a rule selection, which can be provided by an end user, administrator, etc.

In operation, the architecture of the present disclosure can offer an intelligent display for video streams associated with each individual meeting participant of a video session. Meeting participants can be empowered to configure their own video display panels (e.g., a sub-portion of the physical display screen) within a GUI. In at least one sense, each individual is allowed to choose which participants he seeks to visually monitor during the virtual meeting.

FIG. 1B is illustrating a number of example rules that are designated for rendering video data at specific panels. For example, a simple menu could allow for a meeting participant (e.g., at meeting outset) to provision each individual video panel that he seeks to watch during the video conference. Those individual panels would be presented to the user (e.g., on his GUI) per his video stream selections. The term ‘present’ in this context includes any type of displaying, rendering, showing, or otherwise providing video streams (which is inclusive of video data, audio data, multimedia data, etc.) to the user. Consider a scenario in which a given employee at a technology company is anxious to watch the reaction of his manager, as a new product is being presented by a team of engineers. Such a scenario would probably involve the manager having a passive role in the conversations (e.g., the manager would be the target audience that would not be interactive in such a scenario). Without the teachings of the present disclosure, that one-sided conversation would force video streams to be focused on just the active speakers (e.g., the presenting team of engineers).

Active speaker technologies can switch between video channels, as the conversation moves from one participant to another. However, if a given individual in the virtual meeting would like to see a specific nonspeaking participant, he would be forced to navigate through cumbersome drop-down menus, individual settings, etc. In contrast to these activities, communication system 100 is configured to customize each individual panel being rendered on a given graphical user interface (which can be part of any given endpoint). This would allow individual video streams to be intelligently selected by each meeting participant. In certain instances, this individualized provisioning of video streams does not affect the audio streams. Because of the nature of audio, only a single audio stream is generally involved in a conference call (i.e., the user cannot listen to multiple, different audio streams at the same time). Hence, the audio streams would be unaffected by an individualization of a specific rendering of data in the video panels of the user interface.

It is noteworthy to illuminate some of the problematic issues prevalent in video conferencing scenarios. While virtual meeting and conferencing technologies have made organizing and holding meetings more convenient, the context of specific communications within the meetings is often lost. For example, meeting participants cannot see or observe each other in the virtual meeting. Along similar lines, once the meeting has begun, most meeting participants cannot readily recognize the identities of the speakers from their voices. Effective communications includes observations of the actual person who is currently speaking, and/or observing the reactions of other meeting participants. Certain physical and other non-audio movements (such as hand gestures or facial expressions) are an additional form of communication, and these subtle cues provide the necessary context for explicit verbal communications that arise within the virtual meeting.

For instance, visual cues from a person speaking may indicate that the message being delivering is meant to be humorous (e.g., the participant smiles as the message is delivered, rolls his eyes, etc.). Similarly, viewing video of the person who spoke just before the current speaker, or who is an expert in the subject matter being discussed, can further communicate whether that person agrees with/disagrees with, or is confused by the sentiment being expressed by the current speaker. If other meeting attendees are able to view the source of a verbal communication and/or those participants closely associated with the topic of discussion, a better understanding of the communication (being spoken) can be achieved. In strained scenarios, where one or more meeting participants are systematically not visible during a virtual meeting, there is an increased risk of misunderstanding the true meaning behind certain verbal communications.

Instead of these deficient approaches, the platform of the present disclosure allows a given meeting participant to develop rules for monitoring individual video streams. In the example scenario above, simple configuration settings can allow a person to watch the manager's reaction to this presentation and potentially interrupt the presentation (e.g., if there are non-audible cues indicating that the manager is confused, disappointed, etc.). Note that the individual rules can be applied before the meeting commences, applied in real time, applied during recorded session playback, or applied in several of these instances.

The video stream configuration rules can key off active speaker paradigms, or be based on the participant that spoke just before the active speaker. In other scenarios, certain keywords can be used as a trigger for rendering a given video stream. For example, a video stream of a meeting participant can be rendered each time the term ‘budget’ is spoken. Hence, the architecture of communication system 100 can perform speech to text activities in order to identify certain words being spoken by the individual meeting participants, where such words can serve as a trigger for switching the video streams being rendered on a given panel. In yet other examples, emotions can be tracked through facial recognition protocols. For example, rule settings can be used in order to identify emotions related to happiness, excitement, frustration, confusion, etc., during the meeting. Hence, a user is empowered to provision a video stream (for his own screen) that coincides with that particular emotion being expressed by a meeting participant. This would allow a meeting participant to stop the meeting, for example, when someone is confused or frustrated during the conferencing session.

In yet other example implementations, there can be certain rule sets in which two activities occur as a result of an initial trigger. For example, each time the term ‘budget’ is spoken in the call, video panel #1 can render the Vice President's video stream, and video panel #2 can render the participant who connected to the meeting session from Raleigh, N.C. (i.e., a corporate headquarters). In this sense, rules can be dependent on each other and/or trigger each other based on the happenings of the conferencing sessions.

Additionally, certain default rules can be provisioned, where members of the same team (e.g., having the same e-mail suffix, sharing a same business unit, having a certain geographic location for a meeting, etc.) would have automatic provisioning for certain video streams during the virtual meeting. In other instances, the video display panels (within a meeting participant's graphical interface) can be configured to change the video streams being displayed as the meeting progresses (e.g., at minute 15, video streams would be changed for a given individual). In another scenario, social networking can be leveraged in order to determine which video panel should be rendered to a given meeting participant. For example, individual meeting participants that belong to a certain social network would be provisioned by default on the available video panels. Friend lists, Buddy lists, Contacts (through Microsoft Outlook) could similarly be leveraged in order to assist in making these screen allocations for designating video data to be shown at a given endpoint.

In still other examples, hierarchies (e.g., within a company) can be provisioned as default video panel settings. For instance, the video panels can render the highest-ranking employees participating in a given session. Such information can be provisioned using manual settings, gleaned through user login data, or retrieved from specific user profiles, as further discussed below. More generic default settings can include video panel #1 being set as showing the active speaker, video panel #2 being set as showing the previous speaker, video panel #3 being set as the highest ranking officer attending the meeting session, etc. Note that certain rights can be afforded to individual participants in order to control the video stream allocations for other individuals. For example, an administrator may determine that a subordinate should only be privy to certain video streams, and not others. The architecture of communication system 100 has the intelligence to provide such specificity in video stream allocations.

Hence, any number of possible rule configurations can be provided in conjunction with communication system 100 and, accordingly, any such possibilities are clearly within the broad scope of the present disclosure. Many of these possibilities are detailed below with reference to accompanying FIGURES. It should also be noted that the term ‘rule’ is a broad term that encompasses any type of provisioning, designation, assignment, configuration, setting, parameter, guideline, or directive being provided by a particular end user for video data allocations.

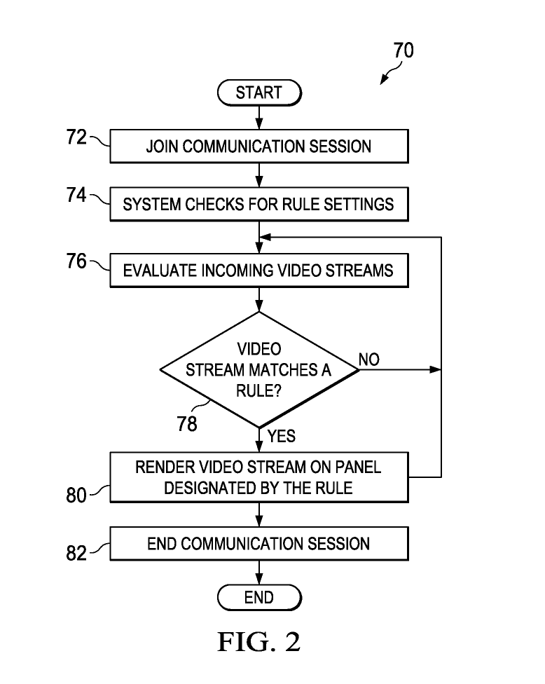

FIG. 2 is a simplified flowchart 70 illustrating a simple operation associated with the present disclosure. In this particular example, a communication session is joined by an end user at 72. In this simplistic example, the communication session is a video conference involving multiple participants, who are operating various types of endpoints. Subsequently, at 74, the architecture can check to see if rule settings have been provisioned for this particular communication session. If no rules have been provisioned, then certain default rendering can occur on a user's screen. For example, a default setting can include active speaker technology being designated for individual panels within a user's screen.

At 76, video streams being received by a given endpoint are evaluated. At 78, a determination is made as to whether the incoming video stream matches a rule provisioned by the end user. If there were no rule provisioned in this scenario, then the flow would return to 76, where incoming video streams will continue to be systematically evaluated. If there were a rule provisioned that matches the video stream, then the video stream would be rendered on a panel designated by the rule, as shown and 80. This particular communication session naturally ends when the meeting is over at 82.

Before turning to additional operational flows and example embodiments of the present disclosure, a brief overview of the infrastructure of FIG. 1A is provided along with basic discussions associated with the display of participants' video data within the communication session. Data center web zone 130 may include a plurality of web servers 132, a database 134, and a recording element 136. Data center web zone 130 can be used to store and collect data that is generated and/or communicated in connection with a virtual conference meeting. Further, recording element 136 can be used to record video, graphic, and/or audio data communicated and shared within a virtual meeting. This can allow for a full multi-media transcript or recording to be generated of the virtual meeting. Such a transcript or recording can then be used by other users who may not have been able to attend the meeting, or used by attendees of the meeting who wish to review the content of the meeting.

Further, data center meeting zone 140 may include a secure sockets layer hardware (SSL HW) accelerator 142, a plurality of multimedia conference servers (MCSs)/media conference controller (MCC) 144 (also referred to herein as MCSs/MCC servers 144), a collaboration bridge 146, a meeting zone manager 148, and a user profile module 150. In general terms, data center meeting zone 140 can include functionality for providing, organizing, hosting, and generating virtual meeting services and sessions for consumption by client endpoints. Further, as a general proposition, each MCS can be configured to coordinate video and voice traffic for a given virtual meeting. Additionally, each MCC can be configured to manage the MCS from data center meeting zone 140.

Note that various types of routers and switches can be used to facilitate communications amongst any of the elements of FIG. 1A. For example, a call manager element 116 and a unified border element 118 can be provisioned between PSTN 122 and Intranet 120. Also depicted in FIG. 1A are a number of pathways (e.g., shown as solid or broken lines) between the elements for propagating meeting traffic, session initiation, and voice over Internet protocol (VoIP)/video traffic. For instance, a client (e.g., endpoints 112a-e) can join a virtual online meeting (e.g., launching integrated voice and video). A client (e.g., endpoint 112a) can be redirected to data center meeting zone 140, where a meeting zone manager 148 can direct endpoint 112a to connect to a specific collaboration bridge 146 for joining an upcoming meeting.

In instances where the meeting includes VoIP/video streams, then the endpoint can also connect to a given server (e.g., MCSs/MCC servers 144) to receive those streams. Operationally, there can be two connections established to collaboration bridge 146 and to MCSs/MCC servers 144. For collaboration bridge 146, which could be implemented in a network element such as a server, one connection can be established to send data, where a second connection can be established to receive data. For MCSs/MCC servers 144, one connection can be established for control, and the second connection can be established for data. Further, other endpoints (also participating in the meeting) can similarly connect to the server (e.g., MCSs/MCC servers 144) to exchange and share audio, graphic, video, and other data with other connected endpoints.

A communication session can include any session involving two or more communication devices transmitting, exchanging, sharing, or otherwise communicating audio and/or graphical messages, presentations, and other data, within a communication system or network. In some instances, communication devices within a communication session can correspond with other communication devices in the session over one or more network elements, communications servers, and other devices, used in facilitating a communication session between two or more communication devices. As one example, a communication session can include a virtual meeting, hosted, for example, by a meeting server, permitting one or more of the participating communication devices to share and/or consume audio data with other communication devices in the virtual meeting. Additionally, in some instances, the virtual meeting can permit multi-media communications, including the sharing of video, graphical, and audio data. In another example, the communication session can include a two-way (or conference) telephonic communication session that may include telephonic communications involving the sharing of both audio and graphical data, such as during a video chat or other session, via one or more multimedia-enabled smartphone devices.

In certain virtual meeting sessions, participants in a virtual meeting may not be able to see or recognize the voice of the participant who is talking at any particular point in the virtual meeting. This can be more common where participants are separated by geography, organization, etc. A virtual meeting environment can include a graphical interface that includes a listing of the participants in the virtual meeting. The graphical user interface may include functionalities that can attribute speech (within the virtual meeting) to a particular meeting participant. In some instances, a virtual meeting can include video display panels for displaying video data communicated by meeting participants (e.g., by using a webcam). Video data can enhance the virtual meeting, allowing participants to see who is speaking or see the reactions of other participants to what is being discussed, displayed, or shared. Video data can help make a virtual meeting environment feel more like an ‘in-person’ meeting. Unfortunately, the display of video data has certain limitations within a virtual meeting environment. Displays on virtual meeting endpoints are restricted in the amount of video data that they can display. That is, endpoint displays have a limited amount of physical area (screen real estate) to display the various video data. Although an endpoint may receive video data associated with many participants (e.g., tens to hundreds of meeting participants), it is preferable to only display a subset of that video data. Further, when a virtual meeting includes the option to display video data, the video data typically must share portions of the display with other graphical data (e.g., participant lists, shared desktop information/presentations, participant chat, etc.), thus, further limiting the area in which the panels can be displayed.

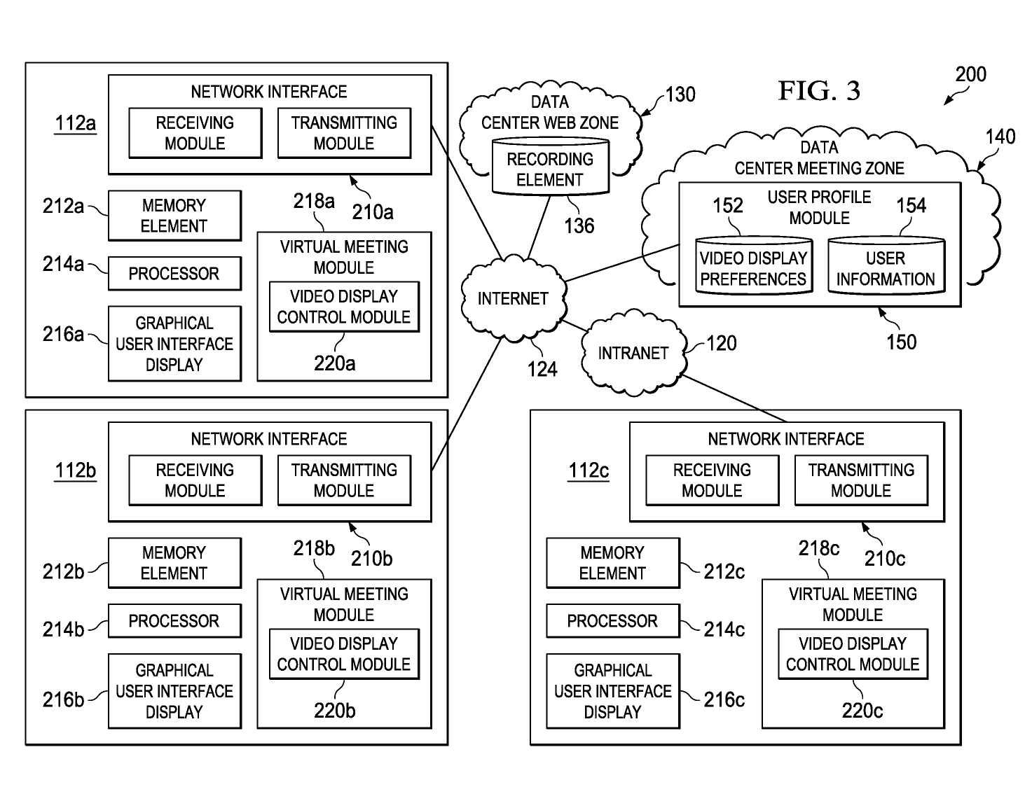

FIG. 3 is a simplified schematic diagram showing one particular example of a selected portion 200 of communication system 100. In this particular example, three communication system endpoints 112a, 112b, and 112c are shown: each adapted to access virtual meeting services provided, at least in part, by data center meeting zone 140 and/or data center web zone 130. For instance, endpoints 112a, 112b, and 112c, such as personal computing devices, can be provided with one or more memory elements 212a-c, processors 214a-c, and graphical user interface display 216a-c. Endpoints 112a, 112b, and 112c can further include network interfaces 210a-c (which may include suitable receiving and transmitting modules) that are adapted to communicatively couple the devices 112a, 112b, and 112c to one or more elements of data center meeting zone 140 and/or data center web zone 130 over one or more networks (e.g., 120 and 124). Endpoints 112a, 112b, and 112c are provisioned with graphical user interface display capabilities that can make use of multi-media offerings of a virtual meeting, including video data. Further, endpoints 112a, 112b, and 112c can include virtual meeting modules 218a-c: permitting each of the endpoints 112a, 112b, and 112c to function as a meeting client in a multi-media meeting environment served using data center meeting zone 140 and/or data center web zone 130. Virtual meeting modules 218a-c can include video display control modules 220a-c that can facilitate and coordinate the display of video data on the graphical user interface displays of endpoints 112a, 112b, and 112c. The term ‘graphical user interface’ is a broad term meant to encompass any type of surface, panel, electronic exterior, overlay, or rendering object that can display, communicate, provide, receive, proxy, or otherwise provide video data. Hence, such a graphical user interface can be part of any type of endpoint, as detailed herein.

As further detailed in FIG. 3, endpoints 112a, 112b, and 112c can be adapted to access and contribute video data of a multi-media virtual meeting served using data center meeting zone 140 and/or web zone 130. In some examples, endpoints 112a, 112b, and 112c can possess more robust video functionality, allowing a user to easily contribute and receive participant video information to (and from) data center meeting zone 140 and/or data center web zone for use in the meeting.

Video display control modules 220a-c can allow endpoints 112a, 112b, and 112c to display received participant video data within video display panels (e.g., smaller display sections of the overall display area of a graphical user interface). Selection and display of received video data can be accomplished through graphical user interface displays 216a-c of each endpoint 112a, 112b, and 112c. Video display control modules 220a-c can provide for a selection of a specific meeting participant's video data based on attributes associated with the meeting participants. The actual attributes can be provisioned in any suitable profile, which is associated with an endpoint/participant of the meeting. Example selections can include, the actively/currently speaking meeting participant, the meeting participant to last speak, job title/roles of participants, keywords spoken by meeting participants, expertise of participants, a participant that is a friend, or any other similar criteria. It should be noted that specific selection criteria for the display of meeting participant video data is functionally limitless. In order to enhance the selection of participant video data, data center meeting zone 140 can further provide meeting participant information through a user profile module 150. The user profile module 150 can store user profile information associated with the meeting participants in a user information element 154. Example profile information can include, name, job title/role, expertise, relationship information, social networking data, or any other similar information.

The user profile module can communicate profile information to endpoints 112a, 112b, and 112c, for use in displaying the video data. Further, endpoints 112a, 112b, and 112c can communicate display preferences from a virtual meeting to the user profile module of data center meeting zone 140 for storage in a video display preference element 152. Storing the video display preferences of a participant in one meeting can allow the participant to carry over those preferences to a later meeting, or ‘default’ the video displays to those previous values at a later meeting. Data center web zone 130 includes recording element 136 that can record the virtual meeting data (including audio, graphical, and video) that can be played back at a later point.

Semantically, a virtual meeting can include a web-based client and server virtual meeting application. A client virtual meeting module (e.g., 218a, 218b, 218c) can be loaded onto an end user's endpoint, for instance, over the Internet via one or more webpages. In another example, a client virtual meeting module (e.g., 218a, 218b, 218c) can be loaded as a software module (e.g., a plug-in) and downloaded (or suitably updated) before participating in a virtual meeting. If the software module is already resident on the end user's endpoint (e.g., previously downloaded, provisioned through any other type of medium such as a compact disk (CD)), then while attempting to participate in a virtual meeting, that software module could be called to run locally on the endpoint. The software download allows the receiving endpoint to conduct the activities discussed herein (e.g., with respect to provisioning video streams on particular panels of a GUI, selecting options from a menu for rendering video data, etc.). More generally, the software download allows a given endpoint to establish a communication with one or more servers (e.g., provisioned at data center meeting zone 140 and/or data center web zone 130, as shown in FIG. 1A), with the corresponding client (e.g., virtual meeting modules 218a, 218b, 218c).

Static data can be stored in data center web zone 130 (e.g., recording element 136). For example, scheduling data, login information, a branding for a particular company, a schedule of the day's events, etc. can all be provided in data center web zone 130. Once the meeting has begun, any meeting experience information can be coordinated (and stored) in any suitable location (e.g., data center web zone 130, data center meeting zone 140, etc.) Further, if an individual shares a document, then that meeting experience could be managed by data center meeting zone 140. In a particular implementation, data center meeting zone 140 can be configured to coordinate the virtual meeting participant video data and the user profile information that is received from endpoints (e.g., 112a, 112b, 112c), which are being operated by the meeting participants.

Endpoints 112a-e (and endpoint 610 discussed below) can be representative of any type of client or user wishing to participate in a communication session in communication system 100 (e.g., or in any other virtual online platform). Furthermore, endpoints 112a-e can be associated with individuals, clients, customers, or end users wishing to participate in a meeting session in communication system 100 (e.g., via some network). The term ‘endpoint’ is inclusive of devices used to initiate a communication, such as a computer, a personal digital assistant (PDA), a laptop or electronic notebook, a cellular telephone of any kind, smartphone (e.g., Android phone, iPhone, etc.), tablet computer (e.g., iPad), or any other device, component, element, or object capable of initiating voice, audio, video, media, or data exchanges within communication system 100. Endpoints 112a-e and endpoint 610 may also be inclusive of a suitable interface to the human user, such as a microphone, a display, or a keyboard or other terminal equipment. Endpoints 112a-e and endpoint 610 may also be any device that seeks to initiate a communication on behalf of another entity or element, such as a program, a proprietary conferencing device, a database, or any other component, device, element, or object capable of initiating an exchange within communication system 100. Data, as used herein in this document, refers to any type of numeric, voice, video, media, or script data, or any type of source or object code, or any other suitable information in any appropriate format that may be communicated from one point to another.

In an example implementation, MCSs/MCC servers 144, web servers 132, and/or a virtual meeting server 630 are network elements that manage (or that cooperate with each other in order to manage) aspects of a communication session. As used herein in this Specification, the term ‘network element’ is meant to encompass any type of servers (e.g., a video server, a web server, etc.), routers, switches, gateways, bridges, loadbalancers, firewalls, inline service nodes, proxies, network appliances, processors, modules, or any other suitable device, component, element, or object operable to exchange information in a network environment. Network elements may include any suitable hardware, software, components, modules, interfaces, or objects that facilitate the operations thereof. This may be inclusive of appropriate algorithms and communication protocols that allow for the effective exchange (reception and/or transmission) of data or information. In one particular example, MCSs/MCC servers 144, web servers 132 are servers that can interact with each other via the networks of FIG. 1A.

Intranet 120, PSTN 122, and Internet 124 represent a series of points or nodes of interconnected communication paths for receiving and transmitting packets of information that propagate through communication system 100. These networks may offer connectivity to any of the devices or endpoints illustrated and described in the present Specification. Moreover, Intranet 120, PSTN 122, and Internet 124 offer a communicative interface between sites (and/or participants, rooms, etc.) and may be any local area network (LAN), wireless LAN (WLAN), metropolitan area network (MAN), wide area network (WAN), extranet, Intranet, virtual private network (VPN), virtual LAN (VLAN), or any other appropriate architecture or system that facilitates communications in a network environment.

Intranet 120, PSTN 122, and Internet 124 can support a transmission control protocol (TCP)/IP, or a user datagram protocol (UDP)/IP in particular embodiments of the present disclosure; however, Intranet 120, PSTN 122, and Internet 124 may alternatively implement any other suitable communication protocol for transmitting and receiving data packets within communication system 100. Note also that Intranet 120, PSTN 122, and Internet 124 can accommodate any number of ancillary activities, which can accompany a meeting session. This network connectivity can facilitate all informational exchanges (e.g., notes, virtual whiteboards, PowerPoint presentations, e-mailing, word-processing applications, etc.). Along similar reasoning, Intranet 120, PSTN 122, and Internet 124 can foster all such communications and, further, be replaced by any suitable network components for facilitating the propagation of data between participants in a conferencing session.

It should also be noted that endpoints 112a-e and MCSs/MCC servers 144 may share (or coordinate) certain processing operations. Using a similar rationale, their respective memory elements may store, maintain, and/or update data in any number of possible manners. Additionally, any of the illustrated memory elements or processors may be removed, or otherwise consolidated such that a single processor and a single memory location is responsible for certain activities associated with talking stick operations. In a general sense, the arrangement depicted, for example in FIG. 3, may be more logical in its representations, whereas a physical architecture may include various permutations/combinations/hybrids of these elements.

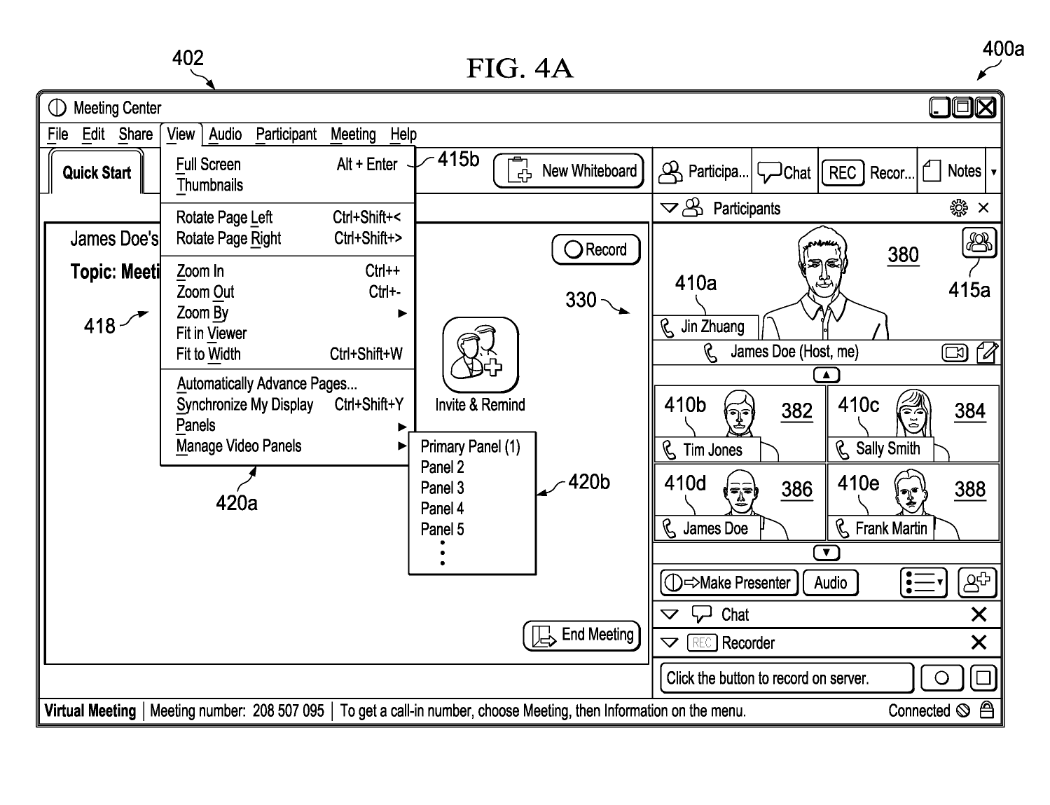

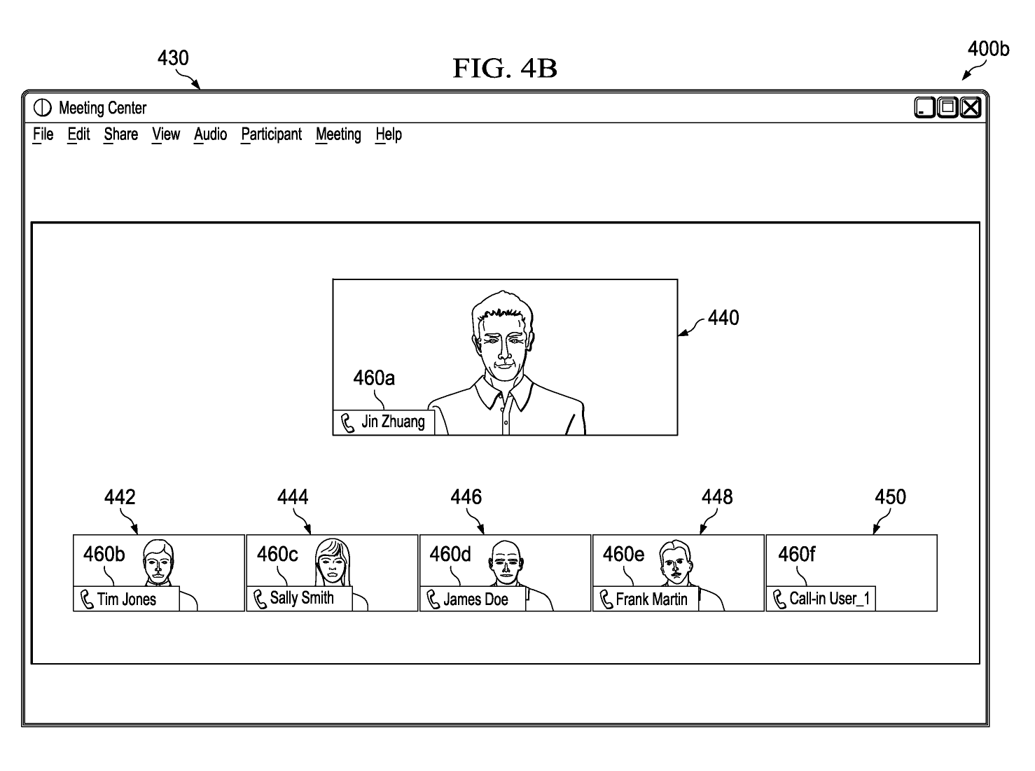

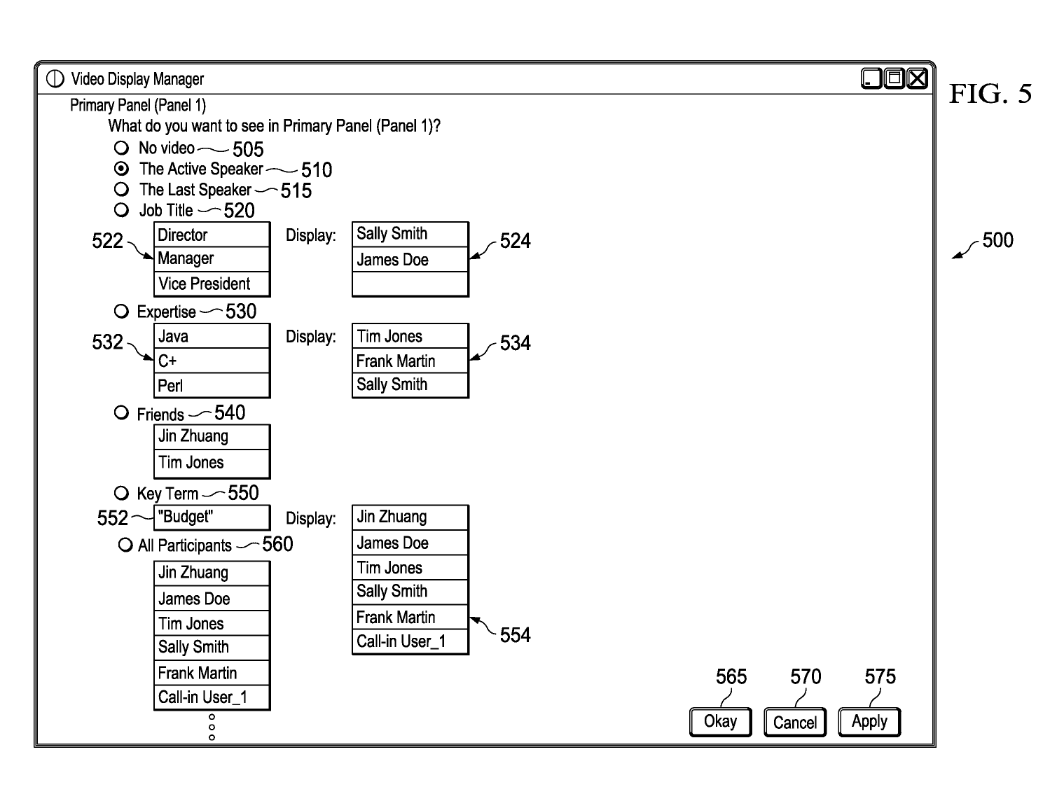

Turning to FIGS. 4A-4B, detailed views 400a and 400b of video data panels associated with participant listing 330 of a graphical user interface 402 are shown. Participant listing 330 can include video display panels 380-388. Video data can be communicated by a meeting server (e.g., a server associated with data center meeting zone 140 of FIG. 1A) to endpoints of meeting participants. The graphical user interfaces of the end user devices can display the video data in video display panels (e.g., 380-388) within participant listing 330. The video data displayed in video display panels 380-388 may include the meeting participant's name that is being displayed in the respective video display panel. The meeting participant's name (e.g., participant names 410a-e) within the video display panel associated with the meeting participant not only identifies the participant, but can also enable access to a functionality that can configure the video data displayed in the panel. Selecting a participant's name 410a-e (e.g., clicking on it) within video display panels 380-388 can enable an interactive window or menu to appear for allowing the participant to choose or control the video data for display in the respective video display panel 380-388. An example video display panel manager is further illustrated in FIG. 5 below. It should be noted that clicking on the participant's name associated with the video display panel is only one technique that could have been used to launch the video display panel manager. It is equally acceptable to enable other aspects of a graphical user interface (inside or outside of a video display panel) to launch a video display panel manager.

Another example method of accessing a video display panel manager is through a menu system associated with a graphical user interface (e.g., 402), such as ‘View’ menu 418. View menu 418 can include an entry option 420a for managing the video display panels. Entry option 420a can include a sub-menu entry option 420b for each of the video display panels (e.g., 380-388). The sub-menu entry options can include a sub-menu entry item for as many video display panels as the graphical user interface allows (where in practice, the significant limitation is the display area of the endpoint). Selecting (e.g., clicking) a sub-menu entry item, can facilitate an interactive window or menu, such as the video panel manager illustrated in FIG. 5. It should be appreciated that there are virtually limitless ways of enabling an interactive window or menu in a graphical user interface, where the examples described above are only offering two such techniques.

Although display of video data in a graphical user interface generally shares display space with other graphical information (e.g., chats or instant messaging, presentations, etc.), sometimes it is preferable to increase the display area of the video data. Illustrated in FIG. 4B is a ‘full screen’ view 400b displaying video data in a graphical user interface 430 of an endpoint for a meeting participant. As an example, graphical user interface 430 can be enabled by a participant of a virtual meeting by interfacing with or clicking on icon 415a or menu item 415b of view menu 418 (i.e., ‘Full Screen’ menu option depicted in FIG. 4A). Graphical user interface 430 can include a primary video display panel 440, along with other video display panels 442-450. Video display panels 440-450 can display video data associated with participants of a virtual meeting. Similar to certain aspects described in graphical user interface 402 of FIG. 4A, a set of participant names 460a-f can be included within video display panels 440-450.

Participant names 460a-f can similarly provide enablement of an interactive window or menu to configure or control the video data that is displayed in the respective video display panel (e.g., the video display manager described in FIG. 5 can be enabled in an interactive window or menu). Although having similar functionality to configure or to control the video displayed within the video display panels as graphical user interface 402, graphical user interface 430 can provide an increased area to display video content of participants in a virtual meeting. The increased area can increase the number of video display panels available to be seen by a participant on an endpoint. Alternatively, the number of video display panels can remain the same; however, the increased area for video data can allow each individual video display panel to be increased in size. By providing configuration capabilities to the meeting participants, and by intelligently allocating the area of the graphical user interface, the user experience (within a virtual meeting environment) can be significantly improved.

FIG. 5 illustrates an interactive display window or menu (e.g., a video display manager interactive window 500) to enable a virtual meeting participant to configure a video display panel in a graphical user interface of an endpoint. A first option 505 can include not selecting a video stream to be displayed in the video display panel. Sometimes, a participant may only be interested in viewing a specific participant, such as the presenter, and could find video streams of other participants distracting. Therefore, it may not be preferable to have video data displayed in all available video display panels. A second option 510 is to display the active speaker in a chosen video display panel (e.g., the participant currently communicating audio data). The active speaker selection can enable the video data of the meeting participant currently speaking to be displayed in the video display panel. Similarly, a last speaker option 515 displays the video data associated with the last meeting participant to have spoken (e.g., communicated audio data).

Additional video display panel options are more complex and may require different data. For example, an option 520 can be to display video of a participant based on the participant's job title/role. Job title/role information can be communicated from meeting participants to user profile module 150 of data center meeting zone 140, as illustrated in FIGS. 1 and 2. The job title/role can be stored in user information element 154 of FIG. 3. Additionally, data center meeting zone 140 can be configured to coordinate the virtual meeting participant video data and user profile information received from endpoints operated by the meeting participants (e.g., via software modules). A display area 522 can display job titles or job roles for participants in the virtual meeting. The job title/role information can be obtained from user information element 154 of data center meeting zone 140.

If a participant selects a specific job title (e.g., manager), the meeting participants that have the job title as part of the user information associated with their profile can be displayed in a second display area 524 (e.g., ‘Sally Smith’ and ‘James Doe’ both have the title ‘Manager’ associated with their user profiles). A participant can then choose the specific meeting participant they would like to display in the selected video display panel. In a similar fashion, the expertise of meeting participants can be provisioned through a display option 530. Again, using the user information associated with meeting participants, a first display area 532 can display the expertise of the participants (e.g., Java, C+, Perl, etc.). A meeting participant can select the expertise of interest (e.g., Perl) and a second display area 534 can display the meeting participants that have the desired expertise in their user profiles. The participant can select the specific expert, and the video data associated with that expert can be displayed in the selected video display panel.

Another selection option 540 can be used to select ‘friends’ or other participants having a relationship with the configuring user. A participant can designate other meeting participants as ‘friends’ that can be stored in user information element 154 (e.g., as part of a user profile). A display area of option 540 can display the ‘friends’ of the user who are attending the virtual meeting. The user can then select the friends' names from the display area, thus displaying the video data in the selected video display panel. Another option 550 allows a user to enter a key term (e.g., ‘budget’) into an input area 552. The user can select a meeting participant from a display area 554. Display area 554 can contain a list of all participants attending the meeting. Key term option 550 can display the video associated with the selected participant from display area 554 when the entered term in input area 552 is spoken by any meeting participant (e.g., the audio data contains the key term). For example, when a meeting participant says the word ‘budget’ the video data associated with the Chief Financial Officer (CFO) can be displayed (e.g., Sally Smith) in a selected video display panel. Thus, the reactions of the CFO can be observed by meeting participants precisely when the budget is being discussed in the meeting.

Another example option 560 is to provide a list of all the meeting participants. The list could allow a user to locate and find any meeting participant for video data rendering, even if the participant does not fall into any other selection option (e.g., options 510, 515, 520, 530, 540, or 550). It should be understood that the discussed options are only representative of a few examples, and that many additional selection options can be implemented to allow a meeting participant to configure or control video data displayed in a video display panel of a graphical user interface associated with an endpoint. Further, the example selection options discussed can be combined or further refined to add or remove certain features. Moreover, an interactive window or menu as described in FIG. 5 is only representative of one example embodiment for allowing a user to configure and control video data displayed in a video display panel. Other techniques, such as ‘drop down’ menus can be equally used without departing from the scope of the present disclosure.

In order to make the desired option selection active and to return to the graphical user interface, the participant can select (e.g., click) an ‘Okay’ button 565. If the participant chooses not to implement a new option selection, he/she can select a ‘Cancel’ button 570. Moreover, if the participant seeks to make a desired option selection active and remain within video display manager interactive window 500, the participant can click an ‘Apply’ button 575. Clicking ‘Okay’ or ‘Apply’ can implement the selected option, which can initiate displaying the video data associated with the option in the video display panel.

Briefly returning to FIG. 4B, an example implementation of video display manager interactive window 500 of FIG. 5 can allow a meeting participant to configure video display panel 440 (e.g., the primary panel or panel 1) to display the video data of the ‘active speaker’. The participant can click on the participant's name information in the video display to launch video display manager interactive window 500. The participant can select the ‘active speaker’ option and click on the ‘Okay’ button, at which time graphical user interface 430 would become active again. The video display panel can now display the video data associated with the selection (e.g., the active speaker is displayed in video display panel 440). The meeting participant can also configure video display panel 442 (e.g., panel 2) to display the video data of the ‘last speaker.’ A similar process can be followed for video display panels 444, 446, 448, and 450 (e.g., panels 3-6).

As noted above, allowing a participant to configure the video display panels in the graphical user interface of the endpoint allows the participant to gain a better understanding of the communications within the virtual meeting. A participant can see the reaction of a CFO when the budget is discussed. A participant can also view the last person who spoke so that the last speaker's reaction can be better understood if the active (e.g., current) speaker is addressing a point discussed by the last speaker. If technical issues are being discussed, the video of an expert in the technical area can be displayed in a video display panel. The flexibility to choose the video data displayed in video display panels of a virtual meeting can make the meeting feel more like an ‘in-person’ meeting and, further, increase the context of the information communicated. Further, visual cues delivered to a meeting participant can be delivered, which engenders a deeper understanding of the verbal communications within the meeting.

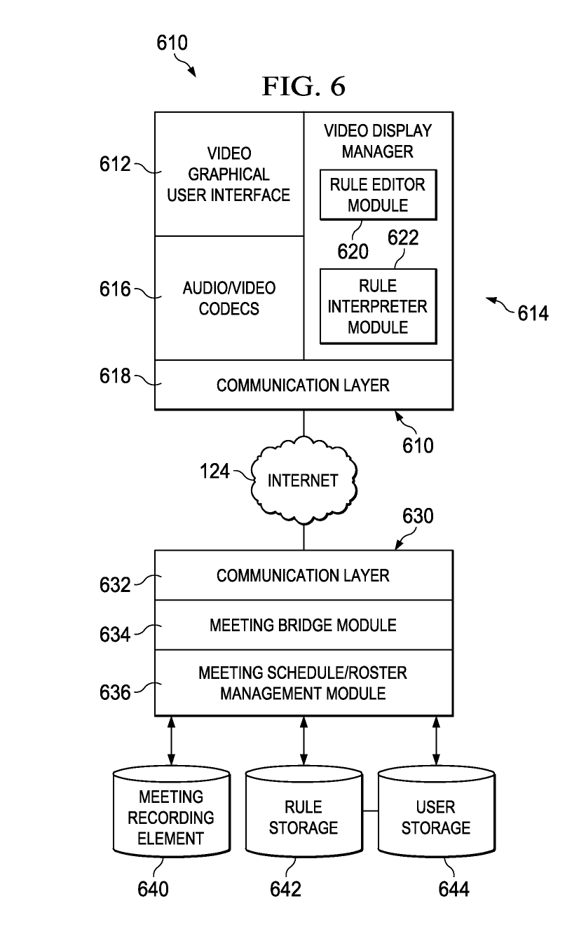

Turning now to FIG. 6, FIG. 6 is a simplified schematic diagram illustrating one particular example architectural implementation of communication system 100. An endpoint 610 can include a video graphical user interface module 612, a video display manager 614, audio/video codecs (compressor/decompressors) 616, and a communication layer 618. Endpoint 610 can be configured to access virtual meeting services provided by virtual meeting server 630 (e.g., through Internet 124). Note that various services provided by virtual meeting server 630 may be provided, at least in part, by elements of data center meeting zone 140 and/or data center web zone 130, as illustrated in FIG. 1A. Virtual meeting server 630 can include a communication layer 632, a meeting bridge module 634, and a meeting scheduler/roster management module 636. Further, virtual meeting server 630 can communicate with a meeting recording element 640, a rule (persistent) storage element 642, and a user storage 644. In general terms, communication layers 618, 632 can cooperate to coordinate, provision, and/or conduct communications between the endpoint and the server. For example, communication layers 618 and 632 can communicate and receive audio, graphical data, video, and any other data type.

Endpoint 610 can communicate with virtual meeting server 630 to schedule and provision a virtual meeting. A meeting scheduler/roster management module 636 of virtual meeting server 630 can schedule and set up a virtual meeting. Meeting bridge module 634 can coordinate and establish a virtual meeting at the desired time. Once connected to a virtual meeting, endpoint 610 can function as a meeting client, being served by virtual meeting server 630. Virtual meeting server 630 can mix the received audio data into a single set of audio data, and communicate the mixed audio data back to the endpoints for consumption. Reciprocally, video data can be communicated by various endpoints associated with meeting participants to virtual meeting server 630. Video streams can be generally made up of video images (e.g., video data of any kind) from web cams associated with the meeting participant's communication devices (e.g., endpoint 610). Unlike audio data, video data is typically not mixed or combined into a single data set. Instead, virtual meeting server 630 communicates the video data separately for each of the meeting participants. Virtual meeting server 630 can also communicate various graphical data associated with the virtual meeting.

Audio/video codecs 616 can be configured to compress audio and video data, to communicate with virtual meeting server 630, and to decompress audio and video data received from virtual meeting server 630. Video graphical user interface 612 can provide video display panels that render video data for selected meeting participants. As noted earlier, it can be desirable to configure various video display panels on an endpoint so that meeting participants can have an enhanced meeting experience. Video display manager 614 allows the meeting participant using endpoint 610 to configure the video display panels within the graphical user interface.

A rule editor module 620 associated with video display manager 614 can display an interactive window (e.g., video display manager interactive window 500 of FIG. 5) to allow a user to configure the video data being displayed on a selected video display panel. Rule editor module 620 provides options to the user to apply to the received video data of a virtual meeting. A rule interpreter module 622 associated with video display manager 614 communicates with rule editor module 620, audio/video codecs 616, and video graphical user interface 612 to carry out the video selection requests. Rule interpreter module 622 can use the selection input from rule editor module 620 to select the video data that corresponds to the selected option. Rule interpreter 622 can then coordinate delivery of the appropriate video data associated with the selected option for video graphical user interface module 612 to display via a graphical user interface (e.g., graphical user interfaces 320, 324, 402, 430).

For audio-based selection options (e.g., ‘active speaker’ or ‘last speaker’), rule interpreter module 622 can also access the audio data to implement the selected option. Moreover, rule interpreter module 622 can access data pertaining to meeting participants' personal information (e.g., name, job title/role, business unit, expertise, social friendships, etc.) that is stored in user storage 644. User storage 644 can maintain various user profile information for virtual meeting participants. During a meeting, virtual meeting server 630 can communicate the user profile information to endpoints for use by rule interpreter module 622 and/or for display by video graphical user interface module 612.

Video display manager 614 can assist a virtual meeting participant in configuring various video display panels in his/her graphical user interface. Such video display panel preferences could transcend the single meeting in which they are set. Thus, endpoint 610 can communicate the video display panel preferences to virtual meeting server 630. Virtual meeting server 630 can store the video display panel preference in rule storage 642. In this manner, when a meeting participant joins a subsequent virtual meeting, he/she can be presented with the option of configuring the video display panels for that meeting in accordance with his/her prior selections. Moreover, meeting recording element 640 can record a virtual meeting for later playback. Meeting recording element 640 can be configured to record a meeting exactly as a particular meeting participant saw the meeting (including the particular video data in the display panel selections). Alternatively, meeting recording element 640 can record all audio, video and graphical data associated with a meeting, thus allowing a participant to playback the recording and apply new video display panel preferences to the playback data of the meeting.

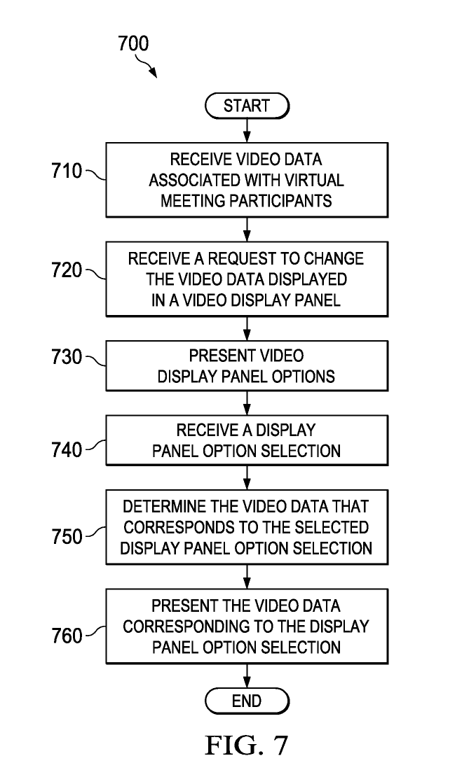

Turning to FIG. 7, FIG. 7 is a simplified flowchart 700 illustrating an example technique for allowing a virtual meeting participant to configure and control video data displayed in a video display panel of a graphical user interface. In this particular example, numerous meeting participants are involved in a network video conference. The meeting has been previously scheduled and coordinated, where various meeting participants have now arrived at the designated time to engage in the meeting session. At 710, video data associated with each of the virtual meeting participants is received. For example, individual video streams can be received at a graphical user interface being monitored by each individual meeting participant.

At 720, a request is received to change the video data displayed in a given video display panel. For example, a server that is involved in coordinating (or otherwise facilitating) this meeting session can receive this request to change the video streams being watched by any one or more individual meeting participants. In response to this request, at 730 a video display panel is presented to the user who initiated the request. For example, a user may have initiated this request in order to offer a designation/preference for which video streams are to be rendered on his display (i.e., the video panels) during a specific time of the virtual meeting. Once he has been provided with the display panel options, the user can then select the appropriate option to designate video streams to be rendered on his graphical user interface. The particular selection can be received at 740, where a given server has the intelligence to determine the video data that corresponds to the display panel option selection. This is being illustrated at 750, where subsequently the video data corresponding to the selection is presented for the user at 760. Note that any number of requests (inclusive of concurrent requests) can be coordinated during the meeting session. Note that the architecture can remember and, hence, automatically populate previous settings, or retrieve preferential settings based on profile information.

It is imperative to note that the present Specification and FIGURES describe and illustrate just one of the multitudes of example implementations of communication system 100. Any of the modules or elements within client endpoints 112a-e (or endpoint 610) and/or meeting servers (e.g., MCSs/MCC servers 144, and virtual meeting server 630) in data center meeting zone 140, etc. may readily be replaced, substituted, or eliminated based on particular needs. Furthermore, although described with reference to particular scenarios, where a given module (e.g., virtual meeting modules 218a-c, user profile module 150, graphical user interface displays 216a-c, etc.) is provided within endpoints 112a-e, endpoint 610, MCSs/MCC servers 144, data center meeting zone, etc., any one or more of these elements can be provided externally, or consolidated and/or combined in any suitable fashion. In certain instances, certain elements may be provided in a single proprietary module, device, unit, etc. in order to achieve the teachings of the present disclosure.

Note that in certain example implementations, the video stream management functions outlined herein may be implemented by logic encoded in one or more tangible media (e.g., embedded logic provided in an application specific integrated circuit (ASIC), digital signal processor (DSP) instructions, software (potentially inclusive of object code and source code) to be executed by a processor, or other similar machine, etc.). In some of these instances, a memory element (as shown in FIG. 3) can store data used for the operations described herein. This includes the memory element being able to store instructions (e.g., software, logic, code, etc.) that can be executed to carry out the activities described in this Specification. A processor can execute any type of instructions associated with the data to achieve the operations detailed herein in this Specification. In one example, the processor (as shown in FIG. 3) could transform an element or an article (e.g., data) from one state or thing to another state or thing. In another example, the activities outlined herein may be implemented with fixed logic or programmable logic (e.g., software/computer instructions executed by a processor) and the elements identified herein could be some type of a programmable processor, programmable digital logic (e.g., a field programmable gate array (FPGA), an erasable programmable read only memory (EPROM), an electrically erasable programmable ROM (EEPROM)) or an ASIC that includes digital logic, software, code, electronic instructions, or any suitable combination thereof.

In one example implementation, each endpoint 112a-e, 610 and/or virtual meeting server 630 can include software in order to achieve the video data management functions outlined herein. For example, this can involve virtual meeting modules 218a-c, user profile module 150, video display manager 614, meeting schedules/roster management module 636, etc. In addition, activities can be facilitated, for example, by any of the infrastructure of FIG. 1A (e.g., MCSs/MCC servers 144, etc.). Additionally, each of these elements may include memory elements for storing information to be used in achieving the functions of communication system 100, as outlined herein. Moreover, each of these elements can include one or more processors that can execute software or an algorithm to perform the video data management functions discussed in this Specification. Further, these devices may further keep information in any suitable memory element (random access memory (RAM), ROM, EPROM, EEPROM, ASIC, etc.), software, hardware, or in any other suitable component, device, element, or object where appropriate and based on particular needs. Any possible memory items (e.g., database, table, cache, etc.) should be construed as being encompassed within the broad term “memory element.” Similarly, any of the potential processing elements, modules, and machines described in this Specification should be construed as being encompassed within the broad term “processor.”

Note that with the examples provided herein, interaction may be described in terms of a certain number or combination elements. However, this has been done for purposes of clarity and example only. In certain cases, it may be easier to describe one or more of the functionalities of a given set of flows by only referencing a limited number of network elements. It should be appreciated that communication system 100 (and its teachings) are readily scalable and can accommodate a large number of connections, rooms, and sites, as well as more complicated/sophisticated arrangements and signaling configurations. It is also important to note that the steps discussed with reference to FIGS. 1-7 illustrate only some of the possible scenarios that may be executed by, or within, communication system 100. Some of these steps may be deleted or removed where appropriate, or these steps may be modified or changed considerably without departing from the scope of the present disclosure. In addition, a number of these operations have been described as being executed concurrently with, or in parallel to, one or more additional operations. However, the timing of these operations may be altered considerably. The preceding operational flows have been offered for purposes of example and discussion. Substantial flexibility is provided by communication system 100 in that any suitable arrangements, chronologies, configurations, and timing mechanisms may be provided without departing from the teachings of the present disclosure.

It should be understood that various other changes, substitutions, and alterations may be made hereto without departing from the spirit and scope of the present disclosure. For example, although the present disclosure has been described as operating in virtual conferencing environments or arrangements, the present disclosure may be used in any communications environment that could benefit from such technology. For example, in certain instances, computers that are coupled to each other in some fashion can utilize the teachings of the present disclosure (e.g., even though participants would be in a face-to-face arrangement).

Numerous other changes, substitutions, variations, alterations, and modifications may be ascertained to one skilled in the art and it is intended that the present disclosure encompass all such changes, substitutions, variations, alterations, and modifications as falling within the scope of the appended claims. In order to assist the United States Patent and Trademark Office (USPTO) and, additionally, any readers of any patent issued on this application in interpreting the claims appended hereto, Applicant wishes to note that the Applicant: (a) does not intend any of the appended claims to invoke paragraph six (6) of 35 U.S.C. section 112 as it exists on the date of the filing hereof unless the words “means for” or “step for” are specifically used in the particular claims; and (b) does not intend, by any statement in the specification, to limit this disclosure in any way that is not otherwise reflected in the appended claims.

What is claimed is:

1. A method, comprising:
receiving video data associated with a plurality of video streams during a communication session;
receiving a rule selection for a particular video stream that is selected from the plurality of video streams; and
displaying the particular video stream based on the rule selection.

2. The method of claim 1, wherein the rule selection includes a designation for a video stream corresponding to an active speaker in the communication session.

3. The method of claim 2, wherein the rule selection includes a designation for a video stream associated with speech that is spoken prior to the active speaker in the communication session.

4. The method of claim 1, wherein the rule selection includes a designation for a video stream associated with a particular word recited in the communication session.

5. The method of claim 1, wherein the rule selection includes a designation for a video stream associated with a profile, which identifies an expertise of a participant of the communication session.

6. The method of claim 1, wherein the rule selection includes a designation for a video stream associated with a profile, which identifies a job characteristic of a participant of the communication session.

7. The method of claim 1, wherein the rule selection is included as part of a default rule setting for which predetermined video streams are designated for particular video panels of the graphical user interface.

8. The method of claim 1, wherein the rule selection includes a designation for a video stream associated with a profile, which identifies a social networking characteristic of a participant of the communication session.

9. The method of claim 1, wherein a recording is generated for the communication session, and the rule selection is maintained for playback of the recording.

10. The method of claim 1, wherein the rule selection is provided in a video display manager configured to offer options for provisioning rules during the communication session.

11. Logic encoded in one or more non-transitory media that includes instructions for execution and when executed by a processor operable to perform operations, comprising:
receiving video data associated with a plurality of video streams during a communication session;
receiving a rule selection for a particular video stream that is selected from the plurality of video streams; and
displaying the particular video stream based on the rule selection.

12. The logic of claim 11, wherein the rule selection includes a designation for a video stream corresponding to an active speaker in the communication session.

13. The logic of claim 12, wherein the rule selection includes a designation for a video stream associated with speech that is spoken prior to the active speaker in the communication session.

14. The logic of claim 11, wherein the rule selection includes a designation for a video stream associated with a particular word recited in the communication session.

15. The logic of claim 11, wherein the rule selection includes a designation for a video stream associated with a profile, which identifies an expertise of a participant of the communication session.

16. The logic of claim 11, wherein a recording is generated for the communication session, and the rule selection is maintained for playback of the recording.

17. An endpoint, comprising:
a memory element configured to store electronic instructions;
a processor operable to execute the instructions; and
a video display manager module coupled to the memory element and the processor, wherein the endpoint is configured for:
receiving video data associated with a plurality of video streams during a communication session;
receiving a rule selection for a particular video stream that is selected from the plurality of video streams; and
displaying the particular video stream based on the rule selection.

18. The endpoint of claim 17, wherein the rule selection includes a designation for a video stream corresponding to an active speaker in the communication session.

19. The endpoint of claim 18, wherein the rule selection includes a designation for a video stream associated with speech that is spoken prior to the active speaker in the communication session.

20. The endpoint of claim 17, wherein the rule selection includes a designation for a video stream associated with a particular word recited in the communication session.

21. A server, comprising:
a memory element configured to store electronic instructions; and
a processor operable to execute the instructions, wherein the server is configured to receive a request from an endpoint for a software download such that the endpoint is configured for:
receiving video data associated with a plurality of video streams during a communication session;
receiving a rule selection for a particular video stream that is selected from the plurality of video streams; and
displaying the particular video stream based on the rule selection.
